(19) United States
(12) Patent Application Publication
(10) Pub. No.: US 2013/0097134 A1
(43) Pub. Date: Apr. 18, 2013

(54) SYSTEM AND METHOD FOR SUBJECT IDENTIFICATION FROM FREE FORMAT DATA SOURCES

(71) Applicants: Douglas Thompson, Skokie, IL (US); Dan Gelfand, Buffalo Grove, IL (US); Stanley Parker, Lake Barrington, IL (US); Po Cheung Ng, Roseville (AU); Eric Haszlakiewicz, Chicago, IL (US)

(72) Inventors: Douglas Thompson, Skokie, IL (US); Dan Gelfand, Buffalo Grove, IL (US); Stanley Parker, Lake Barrington, IL (US); Po Cheung Ng, Roseville (AU); Eric Haszlakiewicz, Chicago, IL (US)

(73) Assignee: TRANS UNION LLC., Chicago, IL (US)

(21) Appl. No.: 13/539,053

(22) Filed: Jun. 29, 2012

Related U.S. Application Data
(60) Provisional application No. 61/547,537, filed on Oct. 14, 2011.

(51) Int. Cl. G06F 17/30

(52) U.S. Cl. 707/696; 707/765; 707/E17.074; 707/E17.005

(57) ABSTRACT

A system and method for indexing and searching a free format data source is provided. Indexing the free format data source includes normalizing data from the free format data source and creating a master index based on the normalized data. The master index may be updated through synchronization with the free format data source when a change in the data occurs. A search query may be executed against the master index and/or one or more child indexes to search for records. The search query may be normalized and transformed before being executed. The master index may be replicated into the one or more child indexes for scaling and load balancing purposes. Searches may be performed by search agents in parallel at the master index and/or the child indexes.

### CROSS-REFERENCE TO RELATED APPLICATION

This application claims priority to U.S. Provisional Application No. 61/547,537, filed Oct. 14, 2011, which is incorporated herein by reference in its entirety.

### TECHNICAL FIELD

This invention relates to a system and method for indexing and search of free format data sources. More particularly, the invention provides a system and method for the identification of subjects from free format data sources.

### BACKGROUND OF THE INVENTION

The consumer lending industry bases its decisions to grant credit or make loans, or to give consumers preferred credit or loan terms, on the general principle of risk, e.g., risk of foreclosure. Credit and lending institutions typically avoid granting credit or loans to high risk consumers, or may grant credit or loans to such consumers at higher interest rates or on other terms less favorable than those typically granted to consumers with low risk. Consumer data, including consumer credit information, is collected and used by credit bureaus, financial institutions, and other entities for assessing creditworthiness and aspects of a consumer's financial and credit history.

In many emerging and developing markets, the available consumer data may be of a lower quality as compared to consumer data available in developed markets. Financial institutions in emerging markets may capture minimal information, such as only a name and address, from its customers. The captured information may be in a free format that is not consistently formatted among different records and consumers. As examples, an entire name and/or an entire address may be captured in a single field, or different consumers may spell the same street names and cities, towns, or villages in different ways. Moreover, the quality of information may be suspect, e.g., a consumer may not know his or her exact date of birth, telephone numbers may change format over time, etc. Also, conversion of information from handwritten documents to electronic records may contribute to errors and misinterpretation of the consumer data.

Traditional consumer data search algorithms that are often used in developed markets do not always perform well on consumer data in emerging markets. Such traditional algorithms rely on consistent formatting of consumer data, more complete information, and information that is in discrete fields, such as house number, street name, telephone, postal code, and identification number. In developed markets, searches on consumer data may be performed relatively quickly by using a well-indexed relational database key that uses a single field, e.g., identification number or telephone, or a composite key, e.g., date of birth and name, name and house number, etc. However, search times and the number of results returned using traditional algorithms on a consumer data relational database in an emerging market may be unacceptable, particularly as the number of records in the database increases, due to the formatting and quality issues described above.

Therefore, there is a need for an improved subject selection system and method that accounts for the formatting and quality issues with consumer data that may be present in emerging markets, in order to, among other things, reduce search times and optimize search results.

### SUMMARY OF THE INVENTION

The invention is intended to solve the above-noted problems by providing systems and methods for indexing and searching free format data sources. The systems and methods are designed to, among other things: (1) index a free format data source into a master index set; (2) update the master index set when there is new and/or updated data in the free format data source; (3) replicate the master index set into one or more child index sets to allow for distributed searching and processing; and (4) perform parallel searching of the master and/or child index sets in response to a search query and return an ordered set of results.

In one embodiment, a search query that includes a search field for identifying a subject consumer may be received at a processor. The search query may be normalized by the processor to produce a normalized search query, based on normalization rules. The normalized search query may be transformed by the processor to produce a transformed normalized search query, based on transformation rules. An index derived from a free format data source may be searched by the processor based on the transformed normalized search query, and a set of search results may be retrieved and transmitted. Search agents may be executed concurrently and in parallel against the index. The set of search results may be ordered based on a scoring of the search result against a relative strength of another search result. The searching of the index may be executed on a child node with the least computing load in order to evenly distribute work and efficiently utilize system resources.

In another embodiment, data from a free format data source may be received at a processor and normalized to produce normalized data. If a master index does not exist that is derived from the free format data source, the master index may be created by the processor at a master node. The normalized data may be stored in the created master index. If the master index does exist, then the existing master index may be updated by the processor with the normalized data. The master index may be in a flat file format. Updating and synchronization of the master index with the free format data source may be performed in response to a database trigger, an application hook, and/or periodically. Child indexes that are derived from the master index may be created by the processor at child nodes. The normalized data in the master index may be replicated from the master index to the child indexes on a periodic or asynchronous basis.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating a system for the indexing and searching of free format data sources.

FIG. 2 is a block diagram of one form of a computer or server of FIG. 1, having a memory element with a computer readable medium for implementing the system for the indexing and searching of free format data sources.

FIG. 3 is a flowchart illustrating operations for indexing and updating information from a free format data source using the system of FIG. 1.

FIG. 4 is a flowchart illustrating operations for replicating a master index set to child index sets using the system of FIG. 1.

FIG. 5 is a flowchart illustrating operations for executing a search query using the system of FIG. 1.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

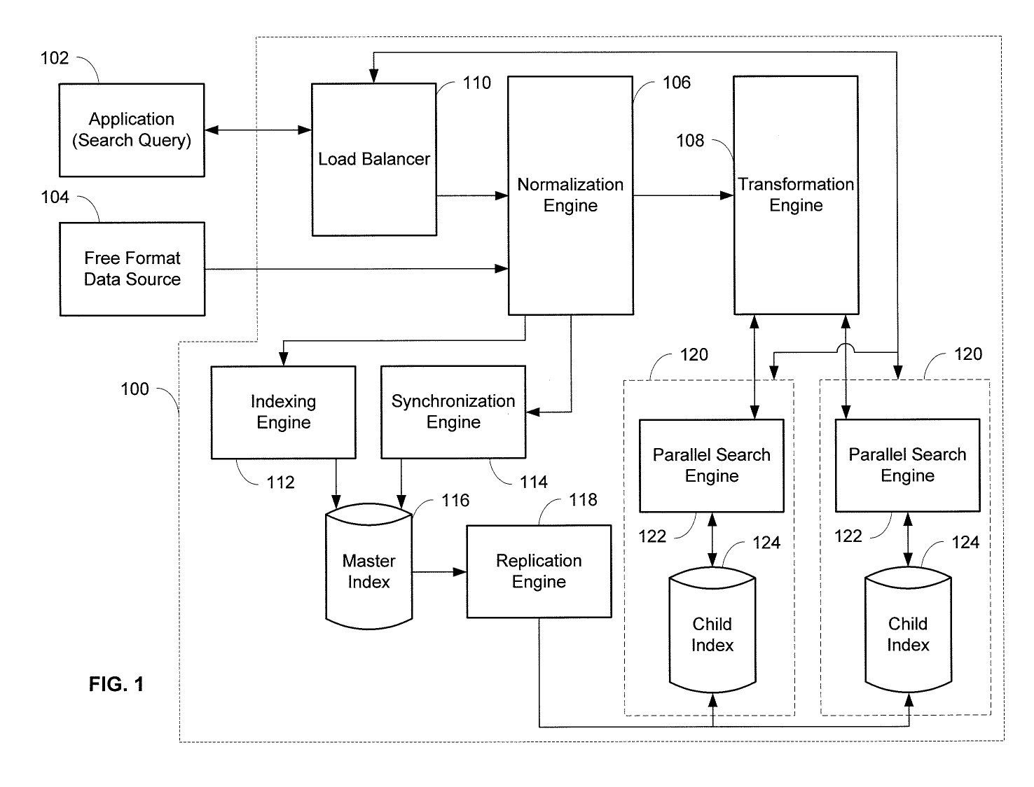

FIG. 1 illustrates a subject identification system 100 for the indexing and searching of free format data sources in accordance with one or more principles of the invention. The system 100 may utilize information derived from a free format data source 104 loaded into the system 100 and information from a search query transmitted to the system 100 to return an ordered set of records as a search result set. A large number of records, e.g., hundreds of millions of records, may be quickly and efficiently searched using the system 100 in order to find the narrowest subset of records with the highest quality, corresponding to a particular search query. The narrowest subset of records may include one or more subject consumers that the search query is attempting to identify. The system 100 may be less computationally expensive than traditional searching algorithms. The returned search result set may be subject to further matching with more refined, but computationally expensive, algorithms. The system 100 may be part of a larger system, such as the International Credit Reporting System (iCRS) from TransUnion.

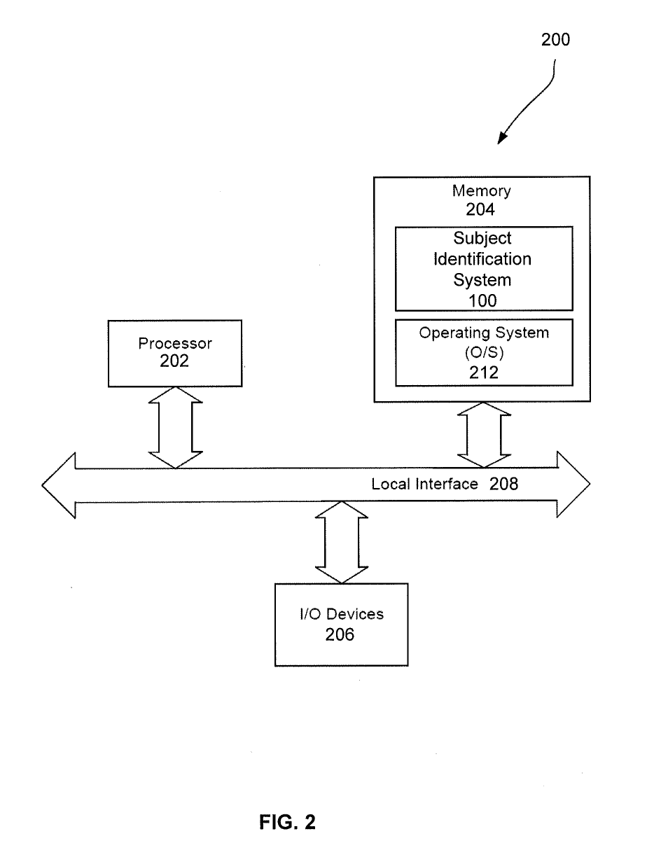

Various components of the system 100 may be implemented using software executable by one or more servers or computers, such as a computing device 200 with a processor 202 and memory 204 as shown in FIG. 2, which is described in more detail below. In one embodiment, the system 100 can index a free format data source 104 into an internal format implemented in a data repository, such as a master index 116 stored in a master node. The master index 116 may be replicated in a child index 124 stored in one or more child nodes 120. In another embodiment, the system 100 can receive a search query from an application 102 to search the data in the master index 116 and/or child indexes 124 and return a set of results. The system 100 may evaluate composite keys containing multiple tokens in an order independent method. This may increase the ability to find potentially matching addresses and names where information within a particular field may be in any order and/or format (e.g., matching of “Jim Alan Michaels” and “Mike James Allan”). In addition, the set of results may be ordered in terms of strength based on the number of tokens matched.

The system 100 may be configurable using XML (Extensible Markup Language) files. For example, various aspects of the structure of the indexes, the degree of search parallelization, search paths, search weightings, normalization, and transformation may be configurable via XML files. Search paths may include, for example, using combinations of consumer information such as name, address, date of birth, phone number, and/or identification number to indentify one or more particular records corresponding to consumers. Communications to, from, and within the system 100 may utilize TCP (Transmission Control Protocol) and the JSON (JavaScript Object Notation) format, although other protocols and formats may be also be utilized. Some or all of the components of the system 100 may be implemented in the Java language or other appropriate programming language. A socket server (not shown) may be included in the system 100 to manage connections with client applications. Multiple requests may be sent through the socket server when a socket connection is maintained, or a new socket connection may be required for each request. Messages sent to the system 100 from client applications may use a defined JSON format.

An application 102 may generate and initiate a search query to retrieve one or more results from the master index 116 and/or child indexes 124 that are derived from the data in the free format data source 104. The application 102 may be a software application, for example, that is executing at a credit bureau and/or at a member of the credit bureau, including financial institutions, insurance companies, utility companies, etc. that wish to retrieve data related to a consumer, such as credit information. For example, a search query may be initiated by a bank when a consumer applies for a loan so that the bank can examine the consumer's credit report to assess the creditworthiness of the consumer. The bank can input the consumer's personal identifying information in the search query in order to retrieve the credit report. The application 102 may transmit a message that contains the search query to the system 100. The message may be in a defined JSON format. The results of the search may be returned to the application 102. In one embodiment, the search results may be refined by a matching algorithm to further narrow the results based on client specifications. The refined search results may then be returned to the application 102 through the socket server, for example. Embodiments of a matching algorithm are disclosed in a concurrently-filed commonly-assigned non-provisional application, titled “System and Method for Matching of Database Records Based on Similarities to Search Queries” (Attorney Docket No. 024080.03US2), which is hereby incorporated by reference in its entirety.

A free format data source 104 may include raw consumer data that is not consistently formatted and/or is unstructured. Consumer data may include identifying information about a consumer as well as financial-related data, such as the status of debt repayments, on-time payment records, etc. Consumer data in the free format data source 104 may originate from a variety of sources, such as members of credit bureaus, including financial institutions, insurance companies, utility companies, etc. The free format data source 104 may include minimal and/or incomplete identifying information in each record corresponding to a customer. Names and addresses of consumers in the free format data source 104 may be arbitrary, vague, and/or non-specific. For example, addresses in the free format data source 104 may include “near the railway station, Guntur”, “the red house south of Joggers park”, or “over by the water tank 30 steps from the village square”. Such addresses may be valid and can receive mail but are non-specific as compared to the address formats used in developed markets. Other data in the free format data source 104 may be duplicative and therefore not unique enough to positively identify a particular consumer by itself. For example, the same account number may be used for loan accounts corresponding to different consumers at different branches of the same bank. In this case, further identifying information must be used to uniquely identify a particular consumer.

Raw data from the free format data source 104 and search queries from the application 102 may be converted with a normalization engine 106. The normalization engine 106 can convert the raw data and search queries into a condensed normalized format to allow for fuzzier matching of data. A portion or all of the raw data and search queries, such as names, addresses, date of birth, etc., may be normalized with the normalization engine 106. Exact and pattern substitutions using regular expressions may be utilized in the normalization engine 106 to convert the raw data. Accordingly, the converted data that is ultimately stored in the master index 116 and/or child index 124 is standardized, as is data contained within search queries. As such, fields in a search query may match the corresponding data in the master index 116 and child indexes 124 because both the fields and the data have been converted with the normalization engine 106.

The normalization engine 106 may include one or more normalization rules. Normalization rules may be customized for the particular market related to the free format data source 104. The normalization rules may include, for example, stripping invalid punctuation, stripping certain invalid and/or non-alphabetic characters, expanding name abbreviations, expanding name words, removing predetermined unwanted noise words and extraneous words, decompressing name words and initials, removing certain duplicate letters, removing vowels from names in certain situations, creating initials from names, etc. For example, abbreviations may be expanded, such as instances of the abbreviation “NY” being normalized to “New York”. As another example, digits in an address may be spelled out, e.g., “1st Street” being normalized to “First Street”. As a further example, common abbreviations for all or part of a name may be expanded, e.g., “Jr.” being normalized to “Junior” or “MoHD” being normalized to “Mohammed”. An example of creating initials from names includes adding “JS” to the name “John Smith” so that initials used in the free format data source 104 and/or the search query may be matched. An example of decompressing name words includes adding “Mary_Beth” to the name “Mary Beth” so that variations on name words used in the free format data source 104 and/or the search query may be matched, e.g., due to spaces, punctuation, etc. between name words.

A transformation engine 108 may apply alterations to search queries that have been normalized by the normalization engine 106. The alterations may allow the search query to be more expansive and inclusive than as specified in the original search query received from the application 102. For example, dates in some countries are specified the MM/DD/YYYY format, while in other countries, dates are specified in the DD/MM/YYYY format. Accordingly, one type of alteration performed by the transformation engine 108 may transpose the month and day of a date of birth in a search query in order to cover both date formats, e.g., including “01/11/2010” in the transformed search query when a date of birth provided in the search query is “11/01/2010”. As another example, transcription errors from handwritten records to electronic records may occur, such as a handwritten “4” looking similar to a handwritten “7” with a dash. In this case, if a search query specifies a date with the year 1974, the transformed search query may also include the year 1977. As a further example, digits of a telephone number may be transposed. In this case, if a search query specifies a telephone number of “1123415”, the transformed search query may also include the phone number “1124315”. Transformed search queries may be sent with or without the original normalized search queries. Transformation rules may be customized for the particular market related to the free format data source 104.

Normalized and transformed search queries may be distributed by the load balancer 110 to an available child node 120 so that the execution of searches is evenly distributed and balanced. The search query transmitted from the load balancer 110 to a child node 120 may also be unaltered from the original search query from the application 102. An agent, such as HAProxy, may be used in the load balancer 110 to detect the availability or unavailability of a child node 120, and can move future search queries to available child nodes 120. The availability or unavailability of a particular child node 120 may be based on a computing load or other parameter. When the child node 120 completes a search, the results of the search may be received by the load balancer 110 and returned to the application 102. In one embodiment, the load balancer 110 may decide on the child node 120 that will execute the search query upon receipt of the search query from the application 102. In another embodiment, the load balancer 110 may decide on the child node 120 that will execute the search query following normalization and/or transformation of the search query.

An indexing engine 112 can perform the initial creation of a data repository, e.g., a master index 116, from the free format data source 104 through performing a complete dataset extraction into a flat file format. The fields within the flat file that is stored in the master index 116 may be configurable by XML file. The initial creation of the master index 116 may be multi-threaded and performed in parallel by the indexing engine 112 and the normalization engine 106 in order to efficiently and quickly create the master index 116. The data repository may also include one or more child indexes 124. The data repository, including the master index 116 and the child indexes 124, are not a relational database, but are flat indexes. The master index 116 and the child indexes 124 may be, for example, compressed reverse b-tree hierarchical data stores. Other formats for the data repository may also be utilized and are contemplated.

The master index 116 may be updated using the synchronization engine 114. The update of the master index 116 may occur based on particular database triggers, hooks in the application 102, and/or on a periodic basis. The database triggers may include, for example, automatic execution of updates to the master index 116 and/or the child indexes 124, in response to a particular event. For example, if a name is enriched, e.g., given more detail, from “Dan Higgens” to “Dan Santo Higgens” in the free format data source 104, a trigger may alert the appropriate processes that a name of a consumer, and therefore the corresponding record associated with the consumer, needs to be updated in the master index 116 and/or child indexes 124. Hooks in the application 102 may include alerting the system 100 of an update in the free format data source 104 when a change has occurred. When the free format data source 104 is changed, the new information may be normalized by the normalization engine 106 before being synchronized to the master index 116 by the synchronization engine 114. Replication of the master index 116 may be performed by the replication engine 118 in order to create updated duplicates of the master index 116 at the one or more child indexes 124. The replication engine 118 may execute periodically and may utilize synchronization scripts similar to Apache's Solr application and a form of the Rsync application to move changes in the master index 116 to the child indexes 124.

As described above, one or more child indexes 124 may be replicated versions of the master index 116. Each child index 124 may be present in a child node 120 that also contains a parallel search engine 122. Although two child nodes 120 are shown in FIG. 1, the number and location of the child nodes 120 is configurable and unlimited in the system 100. The parallel search engine 122 in each child node 120 may be a customized version of the Apache Lucene search engine. Other search engines may also be utilized and are contemplated. The parallel search engine 122 can receive a search query from the application 102 after the search query is normalized and transformed by the normalization engine 106 and transformation engine 108, respectively. The search query may be run in parallel by the search engine 122 against a predetermined number of concurrent search agents that each access the child index 124. The search query may be part of one or more search paths used by the search agents when searching the child index 124. Search paths may include, for example, using combinations of consumer information such as name, address, date of birth, phone number, and/or identification number to indentify one or more particular records corresponding to consumers. When each search agent returns its respective results, the results can be consolidated and returned back to the application 102 through the load balancer 110. In one embodiment (not shown), the search query may be run on the master index 116 to obtain search results.

The search results are not scored against the search query in the parallel search engine 122. Instead, each search result is scored against the relative strength of the search result ahead of it in the result set. This is in contrast to a traditional search algorithm that will return all search results that match the particular search key in a search query. In the parallel search engine 122, the frequency of matched tokens, e.g., sets of characters, in a result may be examined relative to the frequency of matched tokens to other results in the result set. For example, if an address field is split into ten tokens, e.g., house number, building, district, etc., and a first result matches seven tokens and a second result matches five tokens, then the first result would be returned ahead of the second result.

FIG. 2 is a block diagram of a computing device 200 housing executable software used to facilitate the subject identification system 100. One or more instances of the computing device 200 may be utilized to implement any, some, or all of the components in the system 100, including the normalization engine 106, transformation engine 108, load balancer 110, indexing engine 112, synchronization engine 114, replication engine 118, and/or parallel search engine 122. Computing device 200 includes a memory element 204. Memory element 204 may include a computer readable medium for implementing the system 100, and for implementing particular system transactions. Memory element 204 may also be utilized to implement the master index 116 and/or the child indexes 124. Computing device 200 also contains executable software, some of which may or may not be unique to the system 100.

In some embodiments, the system 100 is implemented in software, as an executable program, and is executed by one or more special or general purpose digital computer(s), such as a mainframe computer, a personal computer (desktop, laptop or otherwise), personal digital assistant, or other handheld computing device. Therefore, computing device 200 may be representative of any computer in which the system 100 resides or partially resides.

Generally, in terms of hardware architecture as shown in FIG. 2, computing device 200 includes a processor 202, a memory 204, and one or more input and/or output (I/O) devices 206 (or peripherals) that are communicatively coupled via a local interface 208. Local interface 208 may be one or more buses or other wired or wireless connections, as is known in the art. Local interface 208 may have additional elements, which are omitted for simplicity, such as controllers, buffers (caches), drivers, transmitters, and receivers to facilitate external communications with other like or dissimilar computing devices. Further, local interface 208 may include address, control, and/or data connections to enable internal communications among the other computer components.

Processor 202 is a hardware device for executing software, particularly software stored in memory 204. Processor 202 can be any custom made or commercially available processor, such as, for example, a Core series or vPro processor made by Intel Corporation, or a Phenom, Athlon or Sempron processor made by Advanced Micro Devices, Inc. In the case where computing device 200 is a server, the processor may be, for example, a Xeon or Itanium processor from Intel, or an Opteron-series processor from Advanced Micro Devices, Inc. Processor 202 may also represent multiple parallel or distributed processors working in unison.

Memory 204 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory 204 can have a distributed architecture where various components are situated remote from one another, but are still accessed by processor 202. These other components may reside on devices located elsewhere on a network or in a cloud arrangement.

The software in memory 204 may include one or more separate programs. The separate programs comprise ordered listings of executable instructions for implementing logical functions. In the example of FIG. 2, the software in memory 204 may include the system 100 in accordance with the invention, and a suitable operating system (O/S) 212. Examples of suitable commercially available operating systems 212 are Windows operating systems available from Microsoft Corporation, Mac OS X available from Apple Computer, Inc., a Unix operating system from AT&T, or a Unix-derivative such as BSD or Linux. The operating system O/S 212 will depend on the type of computing device 200. For example, if the computing device 200 is a PDA or handheld computer, the operating system 212 may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system 212 essentially controls the execution of other computer programs, such as the system 100, and provides scheduling, input-output control, file and data management, memory management, and communication control and related services.

If computing device 200 is an IBM PC compatible computer or the like, the software in memory 204 may further include a basic input output system (BIOS). The BIOS is a set of essential software routines that initialize and test hardware at startup, start operating system 212, and support the transfer of data among the hardware devices. The BIOS is stored in ROM so that the BIOS can be executed when computing device 200 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, and Lua. Components of the system 100 may also be written in a proprietary language developed to interact with these known languages.

I/O device 206 may include input devices such as a keyboard, a mouse, a scanner, a microphone, a touch screen, a bar code reader, or an infra-red reader. It may also include output devices such as a printer, a video display, an audio speaker or headphone port or a projector. I/O device 206 may also comprise devices that communicate with inputs or outputs, such as a short-range transceiver (RFID, Bluetooth, etc.), a telephonic interface, a cellular communication port, a router, or other types of network communication equipment. I/O device 206 may be internal to computing device 200, or may be external and connected wirelessly or via connection cable, such as through a universal serial bus port.

When computing device 200 is in operation, processor 202 is configured to execute software stored within memory 204, to communicate data to and from memory 204, and to generally control operations of computing device 200 pursuant to the software. The system 100 and operating system 212, in whole or in part, may be read by processor 202, buffered within processor 202, and then executed.

In the context of this document, a “computer-readable medium” may be any means that can store, communicate, propagate, or transport data objects for use by or in connection with the system 100. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system 100 can be embodied in any type of computer-readable medium for use by or in connection with an instruction execution system or apparatus, such as a computer.

For purposes of connecting to other computing devices, computing device 200 is equipped with network communication equipment and circuitry. In a preferred embodiment, the network communication equipment includes a network card such as an Ethernet card, or a wireless connection card. In a preferred network environment, each of the plurality of computing devices 200 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device 200 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

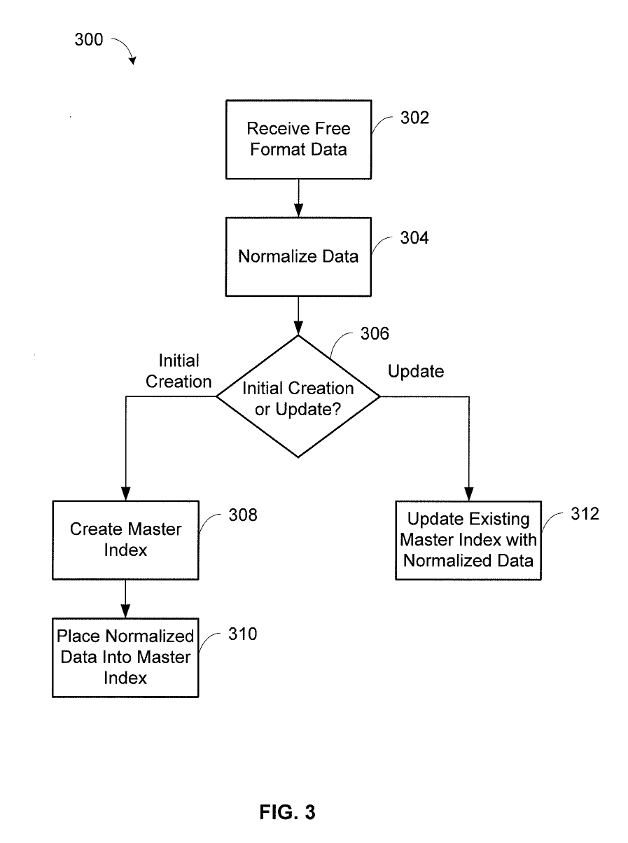

An embodiment of a process 300 for indexing a free format data source 104 is shown in FIG. 3. The process 300 can result in the creation or update of a master index 116 that is based on and derived from the free format data source 104. A free format data source 104 may include raw consumer data that is not consistently formatted or structured, as described above. The free format data source 104 may include minimal information for each record corresponding to a customer. Names and addresses in the free format data source 104 may be arbitrary, vague, and non-specific. Components of the subject identification system 100 may perform all or part of the process 300.

At step 302, free format data may be received at the normalization engine 106 from a free format data source 104. In some embodiments, the free format data may be passed to the normalization engine 106 from a load balancer 110. The free format data may be normalized by the normalization engine 106 at step 304 in order to standardize the data and allow for fuzzier matching of the data in a subsequent search. Normalization of the free format data may be performed in parallel to decrease the processing time for normalization. It may be determined at step 306 whether a master index 116 is to be initially created or updated. A master index 116 may be initially created by the indexing engine 112 when the free format data source 104 has not yet been extracted to a master index 116. An update of the master index 116 may be performed by the synchronization engine 114 when the free format data source 104 has changed and when a master index 116 already exists.

If the master index 116 is to be initially created at step 306, then the process 300 continues to step 308 to create the master index 116 at the master node. The normalized data may then be placed into the created master index 116 by the indexing engine 112 at step 310 and the process 300 is completed. However, if the master index 116 is to be updated at step 306, e.g., because the master index 116 already exists at the master node, then the process 300 continues to step 312. At step 312, the existing master index 116 may be updated with the updated normalized data from the free format data source 104 by the synchronization engine 114 and the process 300 is completed.

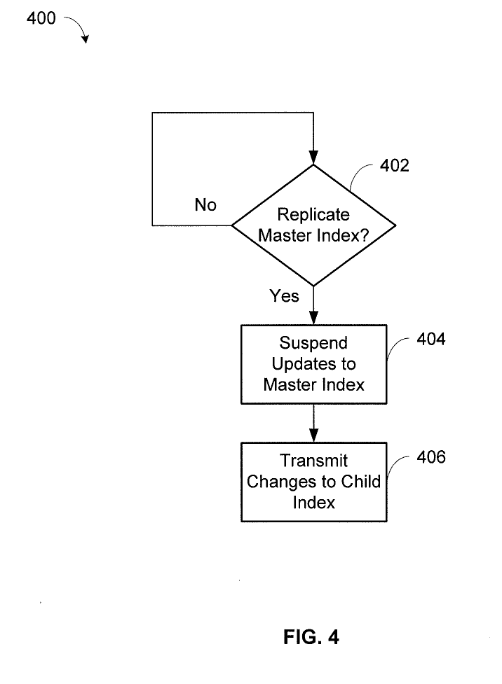

An embodiment of a process 400 for replicating a master index 116 to one or more child indexes 124 is shown in FIG. 4. The process 400 can result in the periodic or asynchronous duplication of the data in the master index 116 to one or more child indexes 124 that are stored at child nodes 120. Components of the subject identification system 100 may perform all or part of the process 400. At step 402, it may be determined whether the master index 116 is to be replicated. The master index 116 may be replicated on a periodic basis, such as hourly, daily, or another time period, and/or on an asynchronous basis based on commands and/or triggers. If the master index 116 is not to be replicated at step 402, then the process 400 stays at step 402 until it is determined that the master index 116 is to be replicated.

However, if the master index 116 is to be replicated at step 402, then the process 400 continues to step 404. At step 404, updates of information, e.g., indexing of free format data from the free format data source 104, to the master index 116 can be suspended so that the replication of the master index 116 to the child indexes 124 is accurate. The master index 116 may also be optimized at step 404. Optimization of the master index 116 may include optimization of the flat file in the master index 116 to allow for faster searching. At step 406, any changes to the master index 116 may be transmitted to the child indexes 124 so that the data in each of the child indexes 124 matches the data in the master index 116 at the time of replication. The changes may be transmitted at a block level. The child indexes 124 may also receive all of the data that is in the master index 116 at step 406 if the child indexes 124 are being initially created, for example. Once the replication of the master index 116 is completed, then the master index 116 may once again receive any updates and the process 400 is completed.

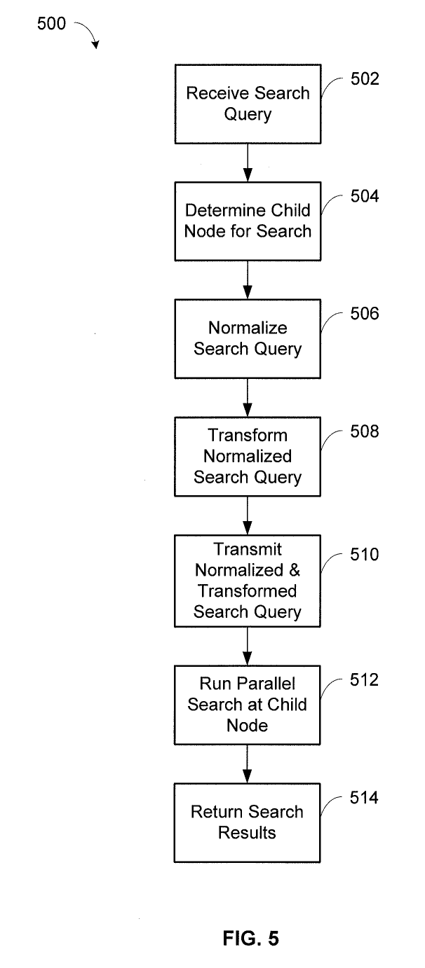

An embodiment of a process 500 for executing a search query of the data in the master index 116 and/or the child indexes 124 is shown in FIG. 5. The process 500 can result in the return of an ordered set of search results to the application 102. Components of the subject identification system 100 may perform all or part of the process 500. At step 502, a search query may be received from the application 102 by the normalization engine 106. The format of the search query may be dynamic, based on the type of search being used. Generally, the search query may be a Boolean construct (e.g., AND, OR, NOT, etc.) of logical objects representing each field being searched against, with the contents of each logical block being the normalized and/or transformed version of the input data for that field.

At step 504, a child node 120 for execution of the search query may be determined by the load balancer 110. The load balancer 110 can determine the child node 120 that has the least computing load so that the execution of searches is evenly distributed and balanced among the child nodes 120. The search query may be normalized by the normalization engine 106 at step 506 so that the terms of the search query may be standardized to match the data in the master index 116 and the child indexes 124 that has previously been normalized. The normalized search query may be transformed at step 508 by the transformation engine 108. Alterations to the terms of the normalized search query may be applied at step 508 to allow for a more expansive and inclusive search of the data in the master index 116 and the child indexes 124, as described above.

Because a child node 120 for execution of the pending search query is determined at step 504, the normalized and transformed search query may be transmitted to the child node 120 at step 510 for execution against the child index 124. At step 512, the search query may be run by the parallel search engine 122 against the child index 124 in the selected child node 120. Execution of the search query may include executing one or more search agents concurrently and in parallel against the child index 124. Each of the search agents may include the normalized and transformed search query. In some embodiments, the search query may be run by a search engine against the master index 116. The search query may be part of one or more search paths used by the search agents when searching the child index 124. Search paths may include, for example, using combinations of consumer information such as name, address, date of birth, phone number, and/or identification number to indentify one or more particular records corresponding to consumers.

Once the results are retrieved, the search results may be returned to the application 102 at step 514, such as through the load balancer 110. The search results may be filtered and/or ordered prior to being returned at step 514. In particular, when ordering the set of search results, each of the search results is not scored against the search query. Instead, each search result is scored against the relative strength of the search result ahead of it in the result set, as described above. Filtering of the set of search results may also be performed, based on parameters set by the user, for example.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A method of searching a free format data source comprising data associated with a plurality of consumers using a processor, the method comprising:
receiving a search query at the processor, wherein the search query comprises a search field for identifying a subject consumer;
normalizing content of the search query using the processor to produce a normalized search query, based on a normalization rule;
transforming the normalized search query using the processor to produce a transformed normalized search query, based on a transformation rule;
searching an index using the processor to retrieve a set of search results based on the transformed normalized search query, wherein the index is derived from the free format data source; and
transmitting the set of search results from the processor, in response to the searching of the index.

2. The method of claim 1, wherein searching the index comprises evaluating one or more tokens of a composite key in any order using the processor, the transformed normalized search query comprising the composite key.

3. The method of claim 1, wherein searching the index comprises executing one or more search agents concurrently and in parallel against the index, using the processor, wherein the one or more search agents comprises the transformed normalized search query.

4. The method of claim 3, wherein the one or more search agents execute a search path based on the transformed normalized search query.

5. The method of claim 1, wherein:
the index comprises a master index stored at a master node and a child index stored at a child node; and
the child index is derived from the master index.

6. The method of claim 5:
the method further comprising determining, using the processor, an availability of the child node for searching the child index based on the transformed normalized search query; and
wherein searching the index comprises searching the child index using the processor to retrieve the set of search results based on the transformed normalized search query, if the child node is determined to be available.

7. The method of claim 6, wherein the availability of the child node comprises a computing load of the child node.

8. The method of claim 1, wherein normalizing the search query comprises evaluating a regular expression to convert the search query to the normalized search query, using the processor.

9. The method of claim 1, wherein transforming the normalized search query comprises adding an alteration to the normalized search query using the processor such that the transformed normalized search query is more expansive than the normalized search query.

10. The method of claim 1, wherein receiving the search query comprises receiving a message at the processor, wherein the message comprises the search query in a defined JSON format.

11. The method of claim 1, wherein searching the index comprises:
retrieving the set of search results from the index based on the transformed normalized search query, using the processor;
scoring a first search result of the set of search results against a relative strength of a second search result ahead of the first search result in the set of search results, using the processor; and
ordering the set of search results based on the scoring to produce an ordered set of search results, using the processor;
wherein transmitting the set of search results comprises transmitting the ordered set of search results from the processor.

12. The method of claim 11, wherein scoring comprises comparing a first matching number of tokens of the first search result with a second matching number of tokens of the second search result.

13. The method of claim 1, wherein:
the search field comprises a plurality of search fields; and
the search query comprises a Boolean construct of the plurality of search fields.

14. The method of claim 1, further comprising refining the set of search results to identify the subject consumer, using the processor, based on a similarity of the set of search results to the search query.

15. A method of indexing a free format data source comprising data associated with a plurality of consumers using a processor, the method comprising:
receiving the data at the processor from the free format data source;
normalizing the data using the processor to produce normalized data;
determining, using the processor, whether a master index exists, wherein the master index is derived from the free format data source and is stored at a master node;
if the master index does not exist:
creating the master index, using the processor; and
storing the normalized data in the master index, using the processor; and
updating the master index with the normalized data, using the processor, if the master index exists.

16. The method of claim 15, wherein normalizing the data comprises evaluating a regular expression to convert the data to the normalized data, using the processor.

17. The method of claim 15, wherein:
receiving the data comprises extracting the data from the free format data source, using the processor; and
storing the normalized data comprises storing the normalized data in the master index in a flat file format.

18. The method of claim 15, wherein updating the master index comprises updating the master index with the normalized data, using the processor, if the master index exists, in response to one or more of a database trigger, an application hook, or expiration of a time period.

19. The method of claim 15, further comprising:
creating a child index stored at a child node, using the processor, wherein the child index is derived from the master index; and
copying the normalized data in the master index to the child index, using the processor.

20. The method of claim 15, further comprising:
replicating the master index to a child index on one or more of a periodic basis or an asynchronous basis;
suspending the updating of the master index during the replicating of the master index; and
resuming the updating of the master index following completion of the replicating of the master index.
